(19) United States
(12) Patent Application Publication
(10) Pub. No.: US 2003/0139078 A1
(43) Pub. Date: Jul. 24, 2003

(54) Light housing adapter

(76) Inventor: Douglas Ruthenberg, Spring Hill, FL (US)

Correspondence Address: MASON & ASSOCIATES, PA, 17757 US HWY 19 N., SUITE 500, CLEARWATER, FL, 33764, US

(21) Appl. No.: 10/053,820

(22) Filed: Jan. 22, 2002

(51) Int. Cl. H01R 33/02

(52) U.S. Cl. 439/236

(57) ABSTRACT

The specification and drawings describe and show one embodiment of the present invention in the form an adapter having a multi-pin connector for connecting a light bulb with a corresponding multi-pin plug to the corresponding multi-pin connector; and a screw-type base portion in electrical communication with the multi-pin connector, the screw-type base portion for connecting into a screw type lamp socket. Ridges are added to facilitate the alignment of an inserted bulb into the adapter. The adapter is preferably made essentially of an integral molded composite material. It is emphasized that this abstract is provided to comply with the rules requiring an abstract that will allow a searcher or other reader to quickly ascertain the subject matter of the technical disclosure. It is submitted with the understanding that it will not be used to interpret or limit the scope of meaning of the claims. 37 CFR 1.72(b).

The invention relates to an adapter for use when retrofitting light bulbs with a screw-type base, with lights which have a multi-pin connection, in most cases, a bi-pin connection.

The adapter is particularly useful when one wishes to use light bulbs, including LED light bulbs, which have multi-pin plugs such as those that plug into Molex® bi-pin connectors, in typical screw-type lamp sockets. The use of LED bulbs is especially useful to generate light shows. Therefore, the ability to convert standard light bulbs in devices such as ground landscaping lighting devices, pool and spa lights or lighted areas around pools and spas, theme rooms/areas, etc., to bulbs which have a multi-pin type of plug provides a convenient and inexpensive way for a consumer to retrofit standard incandescent light bulbs to obtain a dynamic color show.

In the accompanying drawings:

FIG. 1 is a side view of the invention with the screw-type base portion included;

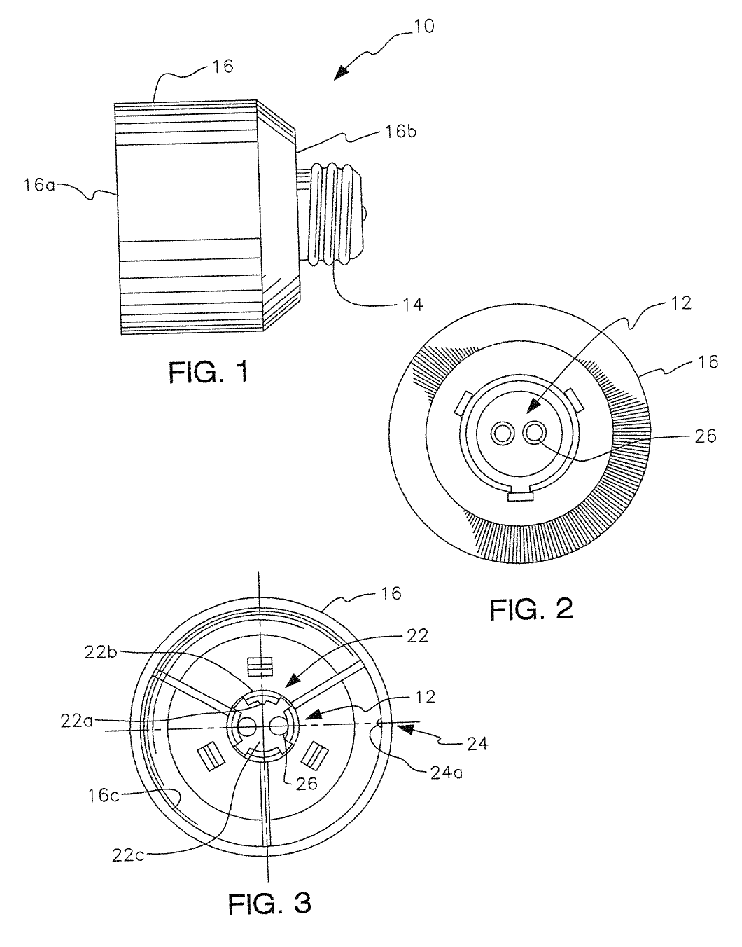

FIG. 2 is a view of the invention looking inside the adapter at the bi-pin portion;

FIG. 3 is a plan view of the portion of the invention to which the screw-type base would connect; and

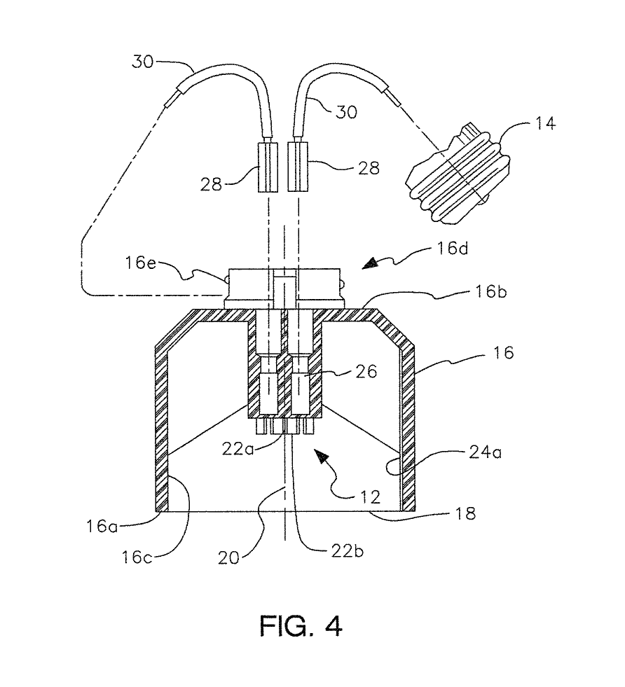

FIG. 4 is a partial cross-sectional view of the invention without the screw-type base assembled to the invention.

Referring now to the drawings, FIGS. 1-4 disclose one embodiment of the present invention, which is an adapter 10 for use when converting from a bulb with a screw-type base 14 to a light bulb with a multi-pin plug. Most such lights on the market have bi-pin plugs; however, it is contemplated that lights with any number of pins for the plug portion fall within the scope of the invention.

The invention is a light housing adapter 10 comprising an adapter 10 having a multi-pin connector 12 for connecting a light bulb with a corresponding multi-pin plug to said corresponding multi-pin connector 12, and a screw-type base portion 14 in electrical communication with the multi-pin connector 12, the screw-type base portion 14 for connecting into a screw type lamp socket.

The adapter 10 has a housing portion 16 having a proximal end 16a and a distal end 16b. The proximal end 16a has an opening 18 for insertion of the light bulb with the multi-pin plug. The distal end 16b is essentially a closed end with the multi-pin connector 12 being located at a geometrically centered axis 20 thereof.

The screw-type base portion 14 is fixedly connected to the distal end 16b.

In an additional embodiment, the light housing adapter 10 further comprises means 22 for guiding and aligning the multi-pin plug into the multi-pin connector 12. The means 22 for guiding and aligning the multi-pin plug into the multi-pin connector 12 is preferably a raised longitudinal ridge portion 22a, the raised ridge portion 22a being parallel to the central axis 20 of the adapter 10. The raised ridge portion 22a is part of a longitudinally extended portion 22b of the multi-pin connector, the longitudinally extended portion 22b generally forming a receptacle receiving area 22c for the multi-pin plug.

In still another embodiment, the light housing adapter 10 further comprises means 24 for guiding and aligning the light bulb with the multi-pin plug through the opening 18 at the proximal end 16a of the housing portion 16. The means 24 for guiding and aligning the light bulb with the multi-pin plug through the opening 18 at the proximal end 16a of the housing portion 16 is preferably a raised longitudinal ridge portion 24a, with the raised ridge portion 24a being parallel to the central axis 20 of the adapter 10. The raised ridge portion 24a typically extends inwardly from an inside surface 16c of the housing portion 16.

The means 22 for guiding and aligning the multi-pin plug into the multi-pin connector 12 and the means 24 for guiding and aligning the light bulb with the multi-pin plug through the opening 18 at the proximal end 16a of the housing portion 16 are preferably oriented about 90 degrees from each other. This will ensure proper alignment and ease for inserting the bulb and for maintaining polarity if polarity is of concern.

The multi-pin connector 12 in most common cases will be a bi-pin connector, similar in structure to those manufactured Molex® Corporation.

The housing portion can be made from a polymeric composite material. The polymeric composite material can be selected from any number of plastic or polymer based materials including polypropylene composites, polyvinyl composites and reinforced nylon composites.

In most cases, the housing portion 16 will be generally cylindrically-shaped but other shapes are contemplated, such as various polygonal shapes.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

Now that the invention has been described,

What is claimed is:

1. A light housing adapter comprising:
an adapter having a multi-pin connector for connecting a light bulb with a corresponding multi-pin plug to said corresponding multi-pin connector; and
a screw-type base portion in electrical communication with the multi-pin connector, the screw-type base portion for connecting into a screw type lamp socket.

2. The light housing adapter according to claim 1, wherein
the adapter has a housing portion having a proximal end and a distal end;
the proximal end having an opening for insertion of the light bulb with the multi-pin plug;
the distal end being essentially a closed end with the multi-pin connector being located at a geometrically centered axis thereof; and
the screw-type base portion being fixedly connected to said distal end.

3. The light housing adapter according to claim 2, further comprising:
means for guiding and aligning the multi-pin plug into the multi-pin connector.

4. The light housing adapter according to claim 3, further comprising:
means for guiding and aligning the light bulb with the multi-pin plug through the opening at the proximal end of the housing portion.

5. The light housing adapter according to claim 3, wherein the means for guiding and aligning the multi-pin plug into the multi-pin connector comprises:
a raised longitudinal ridge portion, said raised ridge portion being parallel to the central axis of the adapter; and
the raised ridge portion being part of a longitudinally extended portion of the multi-pin connector, the longitudinally extended portion generally forming a receptacle area for the multi-pin plug.

6. The light housing adapter according to claim 4, wherein the means for guiding and aligning the light bulb with the multi-pin plug through the opening at the proximal end of the housing portion comprises:
a raised longitudinal ridge portion, said raised ridge portion being parallel to the central axis of the adapter; and
the raised ridge portion extending inwardly from an inside surface of the housing portion.

7. The light housing adapter according to claim 1, wherein the multi-pin connector is a bi-pin connector.

8. The light housing adapter according to claim 2, wherein the housing portion is made from a polymeric composite material.

9. The light housing adapter according to claim 2, wherein the housing portion is generally cylindrically-shaped.

10. The light housing adapter according to claim 4, wherein the means for guiding and aligning the multi-pin plug into the multi-pin connector and the means for guiding and aligning the light bulb with the multi-pin plug through the opening at the proximal end of the housing portion are oriented about 90 degrees from each other.

11. The light housing adapter according to claim 8, wherein the polymeric composite material is selected from the group consisting of polypropylene composites, polyvinyl composites and reinforced nylon composites.
